(19) United States
(12) Patent Application Publication
(10) Pub. No.: US 2026/0219164 A1
(43) Pub. Date: Jul. 30, 2026

(54) FLOW CELL FOR A FLOW CYTOMETER

(71) Applicant: Beckman Coulter, Inc., Brea, CA (US)

(72) Inventors: Simon Alberto NAVA, Miami, FL (US); Evgenia KIM, Palmetto Bay, FL (US)

(73) Assignee: Beckman Coulter, Inc., Brea, CA (US)

(21) Appl. No.: 19/146,000

(22) PCT Filed: Jan. 22, 2024
(86) PCT No.: PCT/US2024/012430

§ 371 Date: Jul. 7, 2025

Related U.S. Application Data
(60) Provisional application No. 63/481,106, filed on Jan. 23, 2023.

(51) Int. Cl. G01N 15/1434; G01N 15/10; G01N 15/1409

(52) U.S. Cl. CPC G01N 15/1436; G01N 15/1409; G01N 2015/1006

(57) ABSTRACT

A high sensitivity flow cell for a flow cytometer including a cuvette. The cuvette having a body including a body height, a body length, and a body width; and a flow channel passing centrally through the body along the body height and having an inner dimension through which a sample flows and intersects with an excitation beam at an interrogation point, wherein the inner dimension has a particular aspect ratio.

This application is being filed on Jan. 22, 2024, as a PCT International application and claims the benefit of and priority to U.S. Provisional Patent Application No. 63/481,106 filed on Jan. 23, 2023, the disclosure of which is hereby incorporated by reference in its entirety.

### BACKGROUND

Flow cytometry in used in the investigation of particles of various sizes by subjecting the particle, while in motion, to spectral and other analytic methods. Sample particles may be suspended in a stream of fluid and excited, charged, or impinged to produce fluorescence and/or scatter or emit light which is detected by the flow cytometer. Flow cytometry allows simultaneous multiparametric analysis of physical and/or chemical characteristics of up to thousands of cells or particles per second. Samples can be characterized, and in some cases sorted, according to size, concentration, and phenotyping. Flow cytometry can be applied to identification and characterization of a wide variety of cell subcomponents, such as vesicles, including extracellular vesicles, mitochondria, nanomedicine and other nanomaterials, proteins, lipids, and nucleic acids.

### SUMMARY

In general terms, this disclosure is directed to a flow cell for a flow cytometer. In some embodiments, and by non-limiting example, a flow cell is provided including a cuvette that improves the sensitivity of the flow cytometer, among other possible benefits and advantages.

Examples of the present disclosure are directed to a high sensitivity flow cell for a flow cytometer including a cuvette. The cuvette having a body including a body height, a body length, and a body width; and a flow channel passing centrally through the body along the body height and having an inner dimension through which a sample flows and intersects with an excitation beam at an interrogation point, wherein the inner dimension has an aspect ratio of at least 2.39. In other examples presented herein, the cuvette further has a curved mirror affixed to the body and configured to reflect side scatter and fluorescence from the interrogation point; and a collection lens disposed opposite from the curved mirror across the width of the body and configured to collect the side scatter and fluorescence directly from the sample and reflected by the curved mirror.

In other examples presented herein, the aspect ratio is at least 3.30. In further examples presented herein, the aspect ratio is 3.33. In still further examples presented herein, the inner dimension has a channel length and a channel width, wherein the channel length is 0.6 mm and the channel width is 0.18 mm.

In other examples presented herein, the inner dimension has a channel length and a channel width, wherein the channel length is 1.3 mm and the channel width is 0.4 mm. In further examples presented herein, the excitation beam is provided by a spatially separate laser.

In other examples presented herein, the excitation beam is provided by a colinear laser. In still other examples presented herein, the body length is at least 2.4× greater than the body width. In further examples presented herein, the curved mirror has a mirror length and the collection lens has a lens length, and each of the mirror length and the lens length at substantially 96% of the body length such that the curved mirror and the collection lens accommodate the wide collection angle of the side scatter produced. In other further examples presented herein, the curved mirror has a mirror length at substantially 90% of the body length such that the curved mirror avoids collecting noise scattered from the flow channel.

In other examples presented herein, the inner dimension and curved mirror are together configured to provide a numerical aperture of at least 1.24. In further examples presented herein, the inner dimension and curved mirror are together configured to provide a numerical aperture of substantially 1.24. In still other examples presented herein, the inner dimension and curved mirror are together configured to provide a numerical aperture of no more than 1.27.

Other examples of the present disclosure are directed to a cuvette for a flow cytometer. The cuvette including a body defining a flow channel having an inner dimension configured to maintain a size and a velocity of a core stream of a sample in a sheath fluid; an interrogation point in the flow channel; and a curved mirror to capture fluorescence emitted and light scattered by the sample at a collection angle and reflect the emitted fluorescence and the scattered light to be collected, the curved mirror configured such that the collection angle is greater than 55 degrees.

In other examples presented herein, the cuvette further includes a collection lens to collect the fluorescence and scattered light directly from the sample and reflected by the curved mirror. In still other examples presented herein, the collection angle is greater than 60 degrees. In yet other examples presented herein, the collection angle is greater than 70 degrees. In further examples presented herein, the collection angle is substantially equal to 72 degrees.

Other examples of the present disclosure are directed to a cuvette for a flow cytometer. The cuvette including a body defining a flow channel having an inner dimension configured to maintain a size and a velocity of a core stream of a sample in a sheath fluid, the body including a body length; an interrogation point in the flow channel; and a curved mirror and a collection lens, together configured to capture fluorescence emitted and light scattered by the sample, wherein each of the curved mirror and the collection lens has a length that is at least 90% of the body length.

### BRIEF DESCRIPTION OF THE DRAWINGS

FIG. 1 is a system diagram of an example flow cytometry system in which an illumination/excitation and detection system embodying aspects of the present disclosure may interrogate a sample with fluidics system 104.

FIG. 2 is an example optical illumination/excitation and detection system of the example flow cytometry system of FIG. 1 and interactions with a flow cell including a cuvette embodying aspect of the present disclosure.

FIG. 3 is a perspective view of an example cuvette embodying aspects of the present disclosure with an example travel path of an excitation laser through the cuvette with collected light at a forward scatter detector.

FIG. 4 is another perspective view of the cuvette of FIG. 3 with an example travel path of an excitation laser through the cuvette with collected light and fluorescence at a side scatter and fluorescence detector.

FIG. 5 is a cross-sectional view of the cuvette of FIG. 3.

FIG. 6 is a top view of the cuvette of FIG. 3.

FIG. 7 is a front view of the cuvette of FIG. 3.

FIG. 8 is a side view of the cuvette of FIG. 3.

FIG. 9 is a rear view of the cuvette of FIG. 3.

FIG. 10 is another side view of the cuvette of FIG. 3.

FIG. 11 is a bottom view of the cuvette of FIG. 3.

FIG. 12 is a diagram of an example side scatter and fluorescence travel path in a cuvette embodying aspects of the present disclosure.

FIG. 13 is a top view of a second example cuvette, according to aspects of the present disclosure.

FIG. 14 is a side view of the second example cuvette of FIG. 13, according to aspects of the present disclosure.

FIG. 15 is a top view of a third example cuvette, according to aspects of the present disclosure.

FIG. 16 is a side view of the third example cuvette of FIG. 15, according to aspects of the present disclosure.

FIG. 17 is a top view of a fourth example cuvette, according to aspects of the present disclosure.

FIG. 18 is a side view of the fourth example cuvette of FIG. 17, according to aspects of the present disclosure.

FIG. 19 is a top view of a fifth example cuvette, according to aspects of the present disclosure.

FIG. 20 is a side view of the fifth example cuvette of FIG. 19, according to aspects of the present disclosure.

FIG. 21 is a top view of a sixth example cuvette, according to aspects of the present disclosure.

FIG. 22 is a side view of the sixth example cuvette of FIG. 21, according to aspects of the present disclosure.

FIG. 23 is a top view of a seventh example cuvette, according to aspects of the present disclosure.

FIG. 24 is a side view of the seventh example cuvette of FIG. 23, according to aspects of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

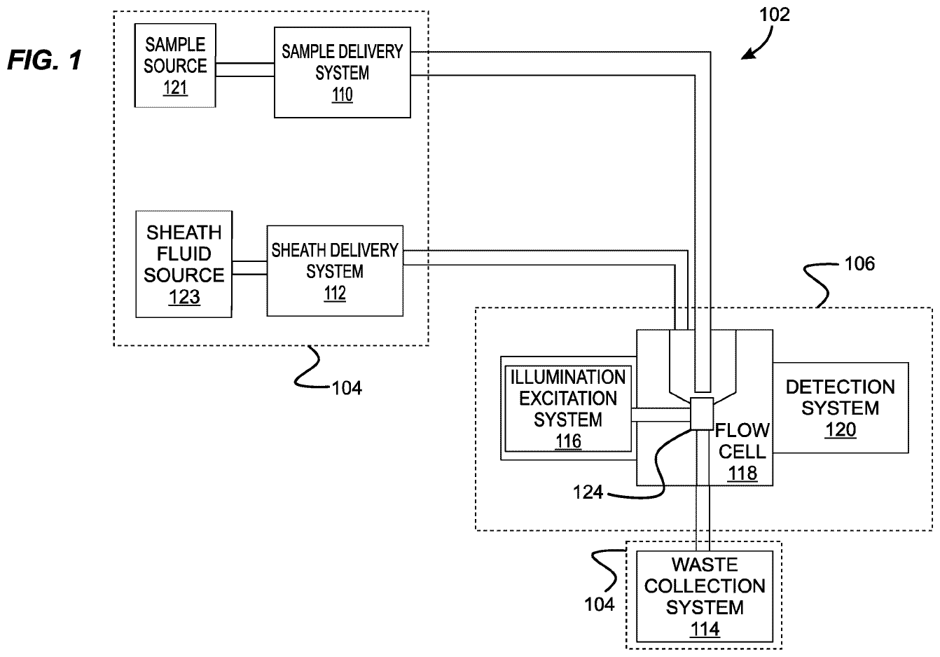

Referring now to FIG. 1, a schematic block diagram of operational components of an example flow cytometry system 102 is shown. In this example, the flow cytometry system 102 includes a fluidics system 104 and a sample illumination/excitation and detection system 106. In some embodiments fluidics system 104 includes a sample delivery system 110, a sheath fluid delivery system 112, and an output collection system 114. The sample illumination/excitation and detection system 106 includes illumination/excitation system 116, a flow cell 118 including a cuvette 124, and detection instruments 120. Also shown are the sample source 121 and the sheath fluid source 123.

Flow cytometry system 102 includes a primary housing for organizing the various components of the flow cytometry system 102, which may include some or all the components of fluidics system 104 and illumination/excitation and detection system 106. Flow cytometry system 102 includes power and communication connections, which supply power to various components of fluidics system 104 or illumination/excitation and detection system 106. Flow cytometry system 102 further includes communication routes between illumination/excitation and detection system 106 and a computing device (not shown). Flow cytometry system 102 may incorporate various components of fluidics system 104, such as supply and waste containers for sample and sheath fluids, or an externally accessible tray for loading one or more samples.

A computing device includes at least a processor and a memory and may be any number of known computing devices or may be a specialized computing device. A computing device is a physical, tangible device that processes data. Example types of computing devices include personal computers, standalone server computers, blade server computers, mainframe computers, handheld computers, smart phones, special purpose computing devices, and other types of devices that process data.

Computing devices generally include at least one central processing unit (“CPU”), a system memory, and a system bus that couples the system memory to the CPU. The system memory includes a random access memory (“RAM”) and a read-only memory (“ROM”). A basic input/output system containing the basic routines that help to transfer information between elements within the device, such as during startup, is stored in the ROM. The device further includes a mass storage device. The mass storage device is able to store software instructions and data.

The mass storage device and its associated computer-readable data storage media provide non-volatile, non-transitory storage for the device. Although the description of computer-readable data storage media contained herein refers to a mass storage device, such as a hard disk or CD-ROM drive, it should be appreciated by those skilled in the art that computer-readable data storage media can be any available non-transitory, physical device or article of manufacture from which the device can read data and/or instructions.

Computer-readable data storage media include volatile and non-volatile, removable, and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the device. In some embodiments, the computer-readable data storage media includes non-transitory media.

The computing device can also include an input/output controller for receiving and processing input from a number of other devices, including a keyboard, a mouse, a touch user interface display screen, or another type of input device. Similarly, the input/output controller provides output to a touch user interface display screen, a printer, or other type of output device.

In embodiments, computing device is fully integrated within flow cytometer 102 and may be operated by buttons, keys, or one or more touchscreens on flow cytometer 102. In examples, computing device may be computer software loaded onto any number of common or custom combinations of processor and memory. Computing device may provide a converting system for converting output detection signals from the high sensitivity detector into computer processible data or may receive the data already converted. Computing device may enable analysis of data produced by the interrogation and detection system 106 and may further provide for an accessible readout of data and analysis of the data.

Flow cytometer 102, including fluidics system 104 and illumination/excitation and detection system 106, and computing device may all be separate components operating remotely from one another, such as across a network, or may be fully integrated into a single housing. In the example embodiment of FIG. 1, fluidics system 104 and interrogation and detection system 106 are depicted as organized within the housing of flow cytometer 102 and computing device is remotely connected to flow cytometer 102. Together, the components of system 100 provide for the analysis of particles and data generated by interrogation of the particles.

Fluidics system 104 generally comprises one or more source or collection containers, as well as transfer components, for storing and moving the fluids necessary for effective operation of the illumination/excitation and detection system 106. Fluidics system 104 generally comprises at least a sample source and delivery system and a waste receiving container. In embodiments, fluidics system 104 also includes a sheath fluid source and delivery system.

The sample delivery system 110 is a system configured to move the sample from the sample source 121 to the flow cell 118. An example of the sample source 121 is a test tube containing the sample. In other embodiments, the sample source 121 is a microplate containing one or more samples. In some embodiments, the sample delivery system 110 is controlled by the computing device.

In some embodiments, fluidics system 104 includes a sheath fluid delivery system 112. The sheath fluid delivery system 112 is a system configured to deliver sheath fluid from the sheath fluid source 123 to the flow cell 118. In some embodiments, the sheath fluid delivery system 112 is controlled by the computing device. As noted above, in some embodiments, the sheath fluid delivery system 112 supplies the sheath fluid to the flow cell 118 where the sheath fluid is incorporated into the core stream. Other embodiments do not include a sheath fluid delivery system.

The waste collection system 114 receives fluid, including the sample and sheath fluid, from the flow cell 118 after the sample has been interrogated by the sample illumination/excitation and detection system 106. In some embodiments, the waste collection system 114 stores samples for subsequent use or disposal. In some embodiments, the waste collection system 114 stores the sample in different locations based on properties of the sample determined by the sample illumination/excitation and detection system 106. In some embodiments, the waste collection system 114 is a passive receptacle of fluid that passes through the flow cell 118. In other embodiments, the waste collection system 114 actively aspirates fluid from the flow cell 118.

Illumination/excitation and detection system 106 enables the analysis of cells or particles moving in a fluid stream and generally includes a flow cell wherein the illumination/excitation and detection system 106 couples to fluidics system 104. The sample illumination/excitation and detection system 106 is a system configured to illuminate and/or excite a sample in a flow stream and collect fluorescence and light scattered or emitted by detection system 120. An example of illumination/excitation system 116 is a laser and one or more optical components to deliver illumination/excitation beam. Other embodiments of illumination/excitation system 116 are possible as well. The illumination/excitation system 116 illuminate a sample as it passes through the cuvette 124 of flow cell 118. The detection system 120 detects at least some of the light emitted, scattered, and/or fluoresced by the sample. The light detected by the detection system 120 can be used to identify the sample or to evaluate properties of the sample, including the identity or properties of individual particles in the sample.

In embodiments, either or both of illumination/excitation system 116 and detection system 120 communicate with a computing device. For example, a computing device operates to control the operation of the flow cytometry system 102 and to analyze the content of the sample. In some embodiments, computing device may be instrument electronics specific to either or both of illumination/excitation system 116 and detection system 120.

Flow cell 118 includes a stream narrowing device and is configured to prepare a fluid containing the sample to enter cuvette 124 for interrogation with the illumination/excitation source. The flow cell 118 directs the fluid containing the sample into the stream narrowing device, creating a core stream. In some embodiments, the core stream also includes sheath fluid surrounding the sample.

The illumination/excitation system 116 illuminates the core stream as it passes through cuvette 124. The detection system 120 detects light transmitted, scattered, and/or fluoresced by the sample to identify the sample and determine its properties. In some embodiments, the sample illumination/excitation and detection system 106 is controlled by a computing device. Further, in some embodiments, the sample illumination/excitation and detection system 106 communicates electrical signals corresponding to the light transmitted, scattered, and/or fluoresced by the sample to the computing device.

The principles described herein can be implemented in various types of flow cytometry systems 102 in various possible embodiments. For example, some embodiments involve a sorting flow cytometer, while other embodiments involve a non-sorting flow cytometer. When implemented as a sorting flow cytometer, the flow cytometry system 102 typically includes sorting control electronics as part of the computing device, a vibration generator coupled to the fluid nozzle (which may be part of or arranged after the flow cell 118, for example), and sorting plates electrically coupled to electrical charge generators, which generate an electric field therebetween to direct drops appropriately as they separate from the core stream into the output collection system 114. The flow cytometry system 102 is an example of a particle analyzer.

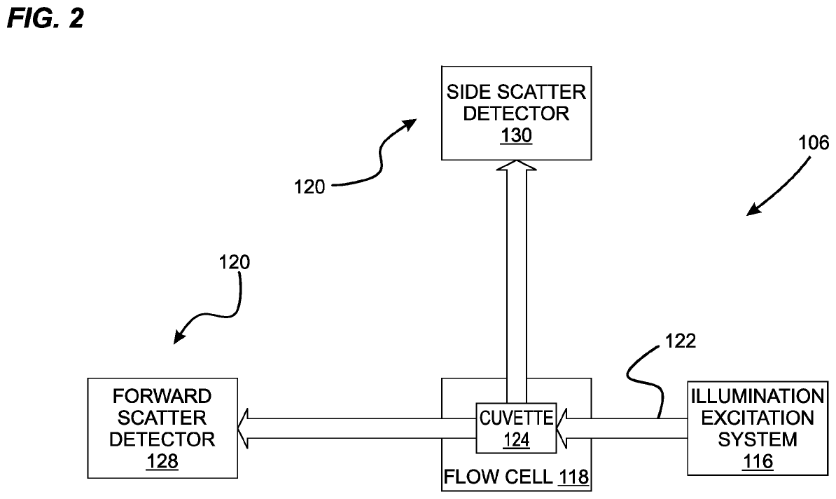

Referring now to FIG. 2, an example optical illumination/excitation and detection system 106 of the example flow cytometry detection system of FIG. 1 and its interaction with a flow cell 118, including a cuvette 124, embodying aspects of the present disclosure.

The illumination/excitation and detection system 106 generally comprises illumination/excitation system 116, flow cell 118, detection instruments 120. Illumination/excitation system 116 directs a beam 122 toward the flow cell 118 and may contain features to direct the beam toward the proper point in the cuvette 124. Detection system 120 receives fluorescence and light scatted or emitted by a sample in the flow cell 118 and generally includes forward scatter detector 128 and fluorescence and side scatter detector 130.

Cuvette 124 provides a point of intersection between fluidics system 104, which controls the movement of the sample, and the illumination/excitation and detection system, which enables the acquisition of data about the sample. A cuvette is an important part of the flow cytometer. The design of the cuvette defines the sensitivity and resolution for the whole instrument. Depending on the specific needs of a particular sample or experiment, the design of the cuvette must accommodate different dimensions and shapes. For a flow cytometry analyzer, sensitivity is the key factor of the success of the instrument making the design of the cuvette, and its effect on sensitivity, central to the success of analysis of any given sample.

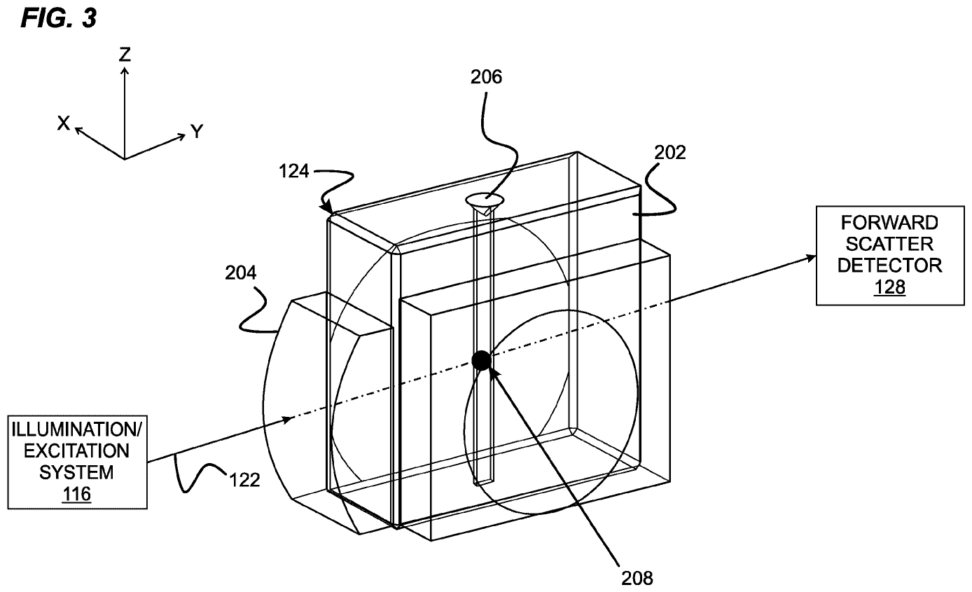

Referring now to FIG. 3, a perspective view of a cuvette 124 embodying aspects of the present disclosure is shown, illustrating the path of beam 122 through cuvette 124 to produce forward scatter. Cuvette 124 comprises a body 202 and a beam shaper lens 204. A flow channel 206 passes through the center of the body 202 and comprises an interrogation point 208.

Body 202 comprises a generally rectangular shape in the example cuvette 124, but other shapes such as cuboid or round bodies are envisioned. Body 202 generally comprises three dimensions, for example, length, width and heigh, or x, y, and z, which determine various characteristics of the flow cell. For example, in cuvette 124, the path of beam 122 through body 202 is along the y-axis, flow channel 206 passes through body 202 along the z-axis, and the x-axis is perpendicular to both of the y-axis and the z-axis. In embodiments, body 202 is prismatically shaped. In embodiments, body 202 is manufactured using UV-fused silica due to its low absorption but can be manufactured from other materials such as glass, fused quartz, or optical grade plastics.

Beam shaper lens 204 generally serves as a focusing lens along a y-axis of an elliptical beam traveling through interrogation point 208. Beam shaper lens 204 is affixed to body 202 and disposed on a face of the cuvette 124 at the entry point of beam 122. In example cuvette 124, beam shaper lens 204 is a cylindrical lens, in particular having a cylindrical axis parallel to the y-axis of body 202. The cylindrical axis of beam shaper lens 204 is oriented perpendicular to the direction in which the liquid sample flow passes through the flow channel 206. Beam shaper lens is formed of UV-fused silica but can be manufactured from other materials such as glass, fused quartz, or optical grade plastics. In embodiments, beam shaper lens 204 is fused or glued to body 202.

Flow channel 206 provides a path along which a sample particle may flow or be carried along, such as by a sheath fluid, to intersect with beam 122 from illumination/excitation system 116. Flow channel 206 is disposed along a centrally oriented z-axis of body 202 and is arranged to be perpendicular to beam 122. Flow channel 206 a rectangular cross-sectional shape, but other cross-section shapes, such as a rounded circular or oblong channel, are envisioned. A sample particle may be carried along flow channel 206 by fluid sample flow, sheath fluid flow, or combined sample and sheath flow.

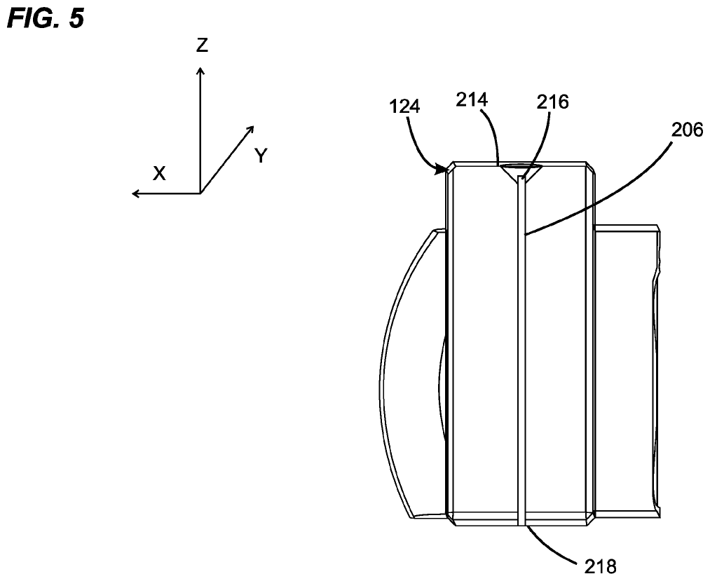

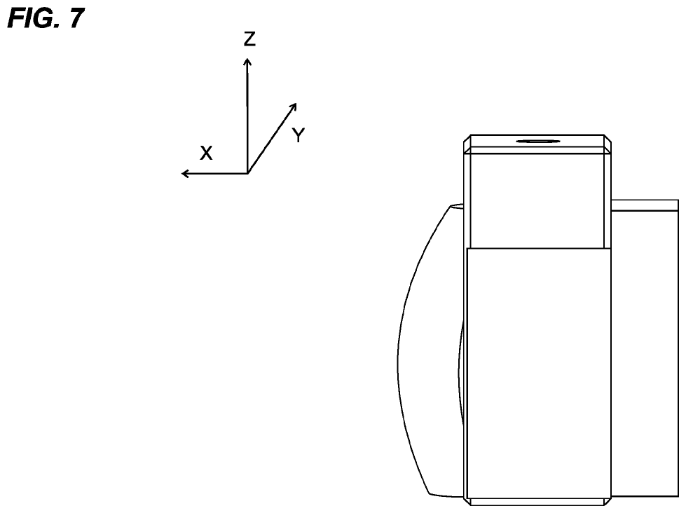

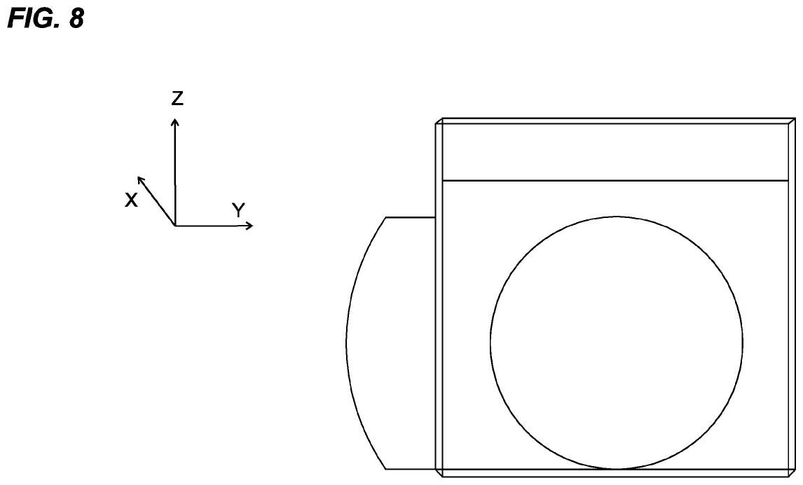

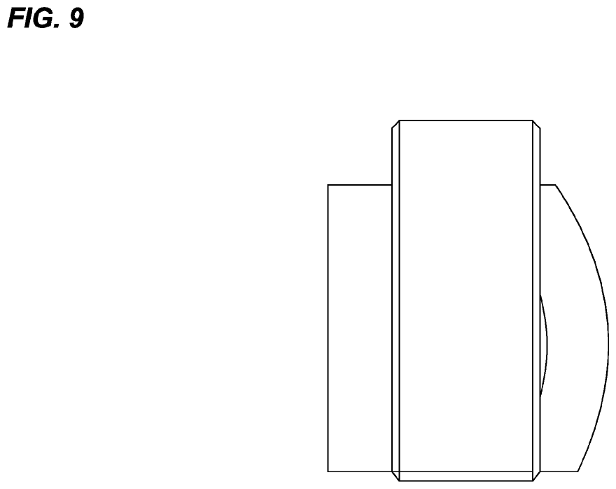

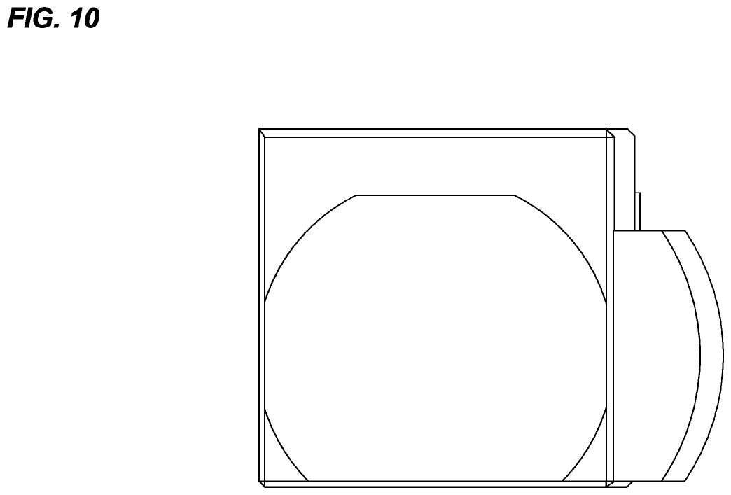

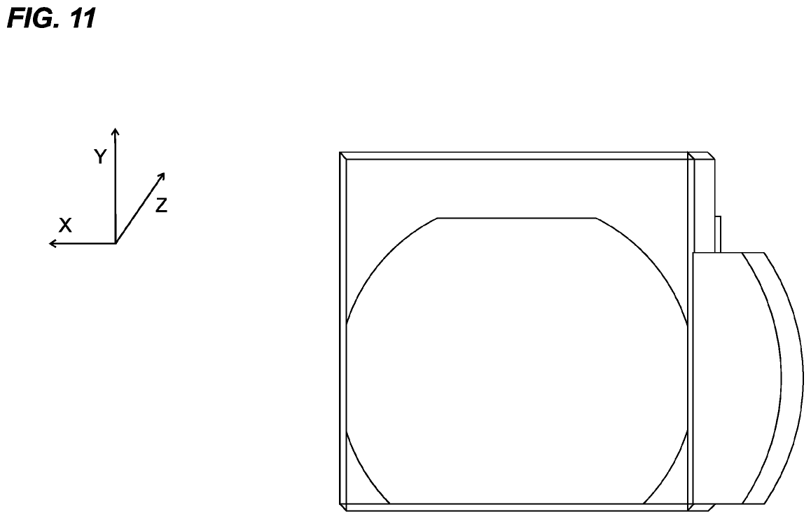

Interrogation point 208 lies at the point of intersection between flow channel 206 and beam 122 from illumination/excitation system 116. Interrogation point 208 is the location of collision between a sample and beam 122 and the point from which fluorescence and/or scattered or emitted light is collected. The components of cuvette 124 are discussed in greater detail in reference to FIGS. 5-11.

Forward scatter detector 128 is any appropriate detection instrument for detecting scattered or emitted light from the sample, and, by way of example, may be a photodiode or a photomultiplier tube.

Beam 122 enters body 202 via beam shaper lens 204 and passes through body 202, along ay-axis, and perpendicularly intersects with flow channel 206 at interrogation point 208. Intersection and subsequent interaction between beam 122 and a sample in flow channel 206 causes light to be scattered or emitted by the sample, producing forward scatter which continues through body 202 in the direction of the y-axis. Forward scatter detector 128 communicates with a computing device, such as computing device. In embodiments, the computing device performs the measuring and analysis of the forward scatter detected by forward scatter detector 128.

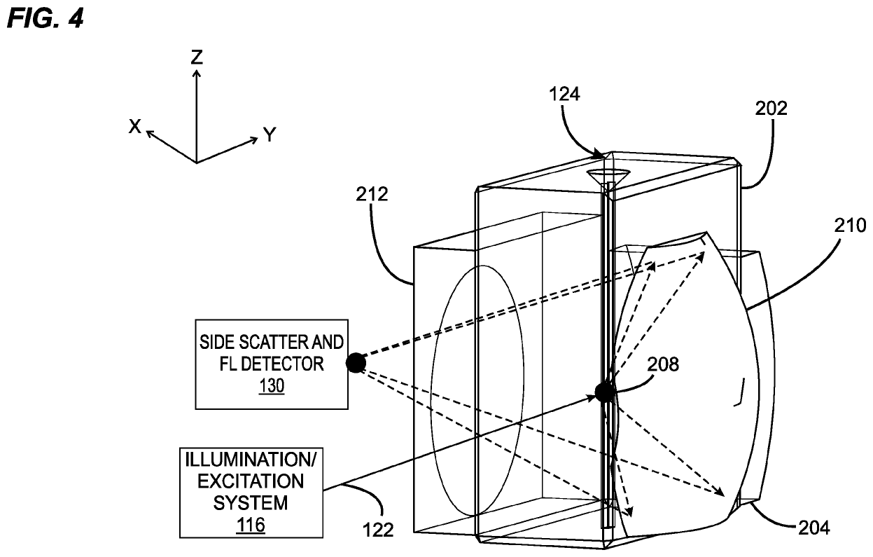

Referring now to FIG. 4, a perspective view of a cuvette 124 embodying aspects of the present disclosure is shown, with the path of the beam 122 through the cuvette 124 to produce fluorescence and/or side scatter illustrated. In addition to the features discussed in reference to FIG. 3 above, cuvette 124 further comprises a curved mirror 210 and a collection lens 212.

Curved mirror 210 is a concave mirror affixed to an x-axis face of body 202. Curved mirror 210 is configured to collect light scattered or fluorescence emitted by a sample and reflect it toward collection lens 212 to be directed toward fluorescence and side scatter detector 130.

Collection lens 212 is disposed opposite of curved mirror 210 and affixed to the opposite x-axis face of body 202. Collection lens 212 serves to focus side scatter and fluorescence emitted, which is reflected by curved mirror 210, toward fluorescence and side scatter detector 130. In embodiments, collection lens 212 may be an asphere lens. The components of cuvette 124 are discussed in greater detail in reference to FIGS. 5-11.

Side scatter and fluorescence detectors 130 are any appropriate detection instrument for detecting scattered or emitted light from the sample, and, by way of example, may be a photodiode or a photomultiplier tube, such as an avalanche PD.

Beam 122 enters body 202 via beam shaper 204 and passes through body 202, such as along a y-axis, and perpendicularly intersects with flow channel 206 at interrogation point 208. Intersection and subsequent interaction between beam 122 and a sample in flow channel 206 causes light to be scattered or fluorescence to be emitted by the sample, producing fluorescence or side scatter which travels away from interrogation point 208 and reflects off curved mirror 210 which directs the scatter or fluorescence toward collection lens 212. Collection lens 212 collects the side scatter and directs it to side scatter and fluorescence detectors 130. Collection lens 212 also receives fluorescence and side scattered light directly from the interrogation point 208. In embodiments, collections lens 212 may be an asphere lens.

For nano flow cytometry, light scattering from the nanoparticles is orders of magnitude smaller than from microparticles, therefore optimized designs of flow cells and cuvettes for flow cytometry are disclosed herein to provide greater sensitivity and effectiveness at reduced scales. Conventional nano flow assemblies suffer from low sensitivity from nanoparticles, such as extracellular vesicles, at slow sheath flow rates and low fluorescence sensitivity at narrow emission bins. Similarly, for spectral flow cytometry, the emission bins are narrower than in a conventional flow cytometer and as a result the fluorescence signal is smaller from the same sample, therefore flow cell designs disclosed herein are optimized to provide improved spectral performance.

The inner dimensions of the flow channel provide features for the control of the flow rate of the sample and sheath fluid, as well as interacting with collection optics that focus the scattered or emitted light or emitted fluorescence into the sample. Collection optics generally consist of a curved mirror, such as curved mirror 210, and an collection lens, such as collection lens 212, that are glued or fused together from both sides of a cuvette, such as cuvette 124. Together the mirror and the lens enable effective collection efficiency of the fluorescence and/or the light that scatters or emits at the interrogation point inside the channel. The physical dimensions of the channel and curved mirror determine the numerical aperture of the assembly, which in turn enables calculation of the collection angle.

Referring now to FIG. 5, a cross section of example cuvette 124 is shown. The cross section of FIG. 5 provides a full view of flow channel 206. In addition to interrogation point 208, flow channel 206 comprises an entry point 214, a flow focusing region 216, and an exit point 218.

Aspects of the present disclosure provide a flow cell that provides for a wider collection angle for the scattered/emitted light and enables increased sensitivity of the assembly. Due to the changes in the channel design to provide the increased collection angle, the average velocity of the sheath is increased. By adjusting sheath and sample flow rates it becomes possible to achieve the proper core stream size at the illumination/excitation point. Core stream size should be similar or smaller than the size of the excitation beam at the illumination/excitation point.

In aspects of the present disclosure, the dimensions of the flow channel are expanded. This increase in the flow channel size opens up the collection angle and enable the collection of a greater amount of light. Further, to provide a sample velocity which permits effective illumination/excitation with the substantially wider channel dimensions, the sheath flow rate is significantly increased. An advantageous outcome of the faster sheath flow rate is that it enables the splitting of the excitation pulses of the several laser sources and as a result creates a spatially separated design where each laser can have designated time delay. To focus the scattered/emitted light or fluorescence, this aspect of the present disclosure may further incorporate an asymmetrical design from both sides of the channel.

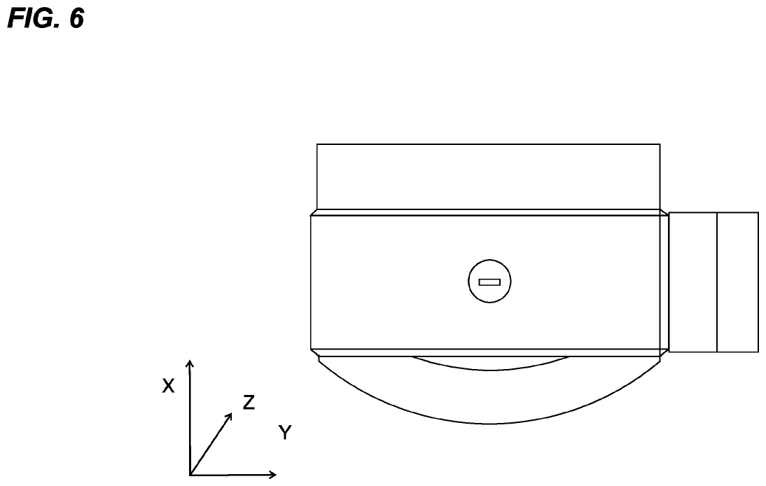

Referring now collectively to FIGS. 6-11, shown are various views of example cuvette 124. Cuvette 124 generally comprises body 202, beam shaper lens 204, flow channel 206, curved mirror 210, and collection lens 212.

Dimensions of body 202 are determined according to fluidics requirements and effective focusing of excitation light scatter or emitted from interrogation point 208. Body 202 generally comprises three dimensions, for example, length, width and heigh, or x, y, and z, which determine various characteristics of the cuvette. Body 202 generally has a rectangular shape with the y-dimension and the z-dimension substantially equal, and both are between 2 and 3 times, between 2.4 and 2.9 times, between 2.43 and 2.87 times larger than the x-dimension. In embodiments, each of the y- and z-dimensions may be substantially 2.44 or 2.86 times the y-dimension. In embodiments, the y-dimension is between 8 and 12 mm, between 9 and 11 mm, or approximately 10 mm; the x-dimension is between 3.00 and 5.00 mm, between 3.40 mm and 4.50 mm, between 3.50 and 4.10 mm, or substantially equal to 3.50 mm or 4.10 mm; and the z-dimension is between 8 and 12 mm, between 9 and 11 mm, or approximately 10 mm.

Beam shaper lens 204 may be plano-aspheric and made of an optically transparent material that may have a refractive index similar to that of body 202. Optical coupling of the beam shaper lens 204 to body 202 may be accomplished, for example, by an index-matching gel, optical adhesive, or direct optical bonding.

Flow channel 206 directs the sample and sheath fluid, where used, and provides inner dimensions to determine the characteristics of the core stream. Flow channel 206 has inner dimensions in three directions (e.g., length, width, and heigh, or x, y, and z). While the height (z-dimension) of flow channel 206 generally follows from the height of body 202, the length and width of flow channel 206 may be tuned to provide a desired velocity and core stream size within the flow channel. Flow of the sample and sheath fluid is tuned to provide a single file line of sample particles down the center of flow channel 206, and this line of sample particles makes up the core stream. Core stream size varies based upon the inner dimensions of the channel and the flow rate of the sample and sheath fluid. Velocity of the sample and sheath fluid also depend upon the inner dimensions of flow channel 206, making the inner dimensions of the flow channel key to achieving effective fluidics in the cuvette 124. In embodiments, the core stream may be tuned to be substantially equal to or smaller than the illumination/excitation beam size.

Increasing the inner dimensions of flow channel 206 along the Y-axis has an advantageous effect of providing a wider collection angle and increasing the sensitivity of the flow cytometer. However, it also influences velocity and size of the core stream and may have simultaneous effects which require fine tuning to achieve the necessary fluidics character at the desired collection angle. In embodiments, flow channel velocity may be sufficiently increased to permit splitting of excitation pulses from multiple lasers or other illumination/excitation instruments, resulting in spatially separated design in the detected scatter with each laser having a designated time delay.

The inner dimensions of flow channel 206 may be characterized through their aspect ratio, which is the ratio of the channel's width to its height. Flow cell assemblies embodying aspects of the present disclosure may have aspect ratios of greater than 3.00, greater than 3.10, greater than 3.20, greater than 3.30, or greater than 3.40. Example flow cell assemblies embodying aspects of the present disclosure have an aspect ratio substantially equal to 3.25, 3.30, 3.33, or 3.40.

Interrogation point 208 provides the point of intersection between the flow channel 206 and an excitation beam entering the cuvette 124. Interrogation point 208 is the point from which the forward scatter and side scatter emit. The detection and direction elements, such as beam shaper lens 204, curved mirror 210, and collection lens 212 receive light scattered or emitted or fluorescence from interrogation point 208.

In embodiments, interrogation point 208 may be shifted, such as by shifting each of beam shaper lens 204, curved mirror 210, and collection lens 212 upward (toward the face of body 202 where sample entry occurs), to increase light collection efficiency. In embodiments, beam shaper lens 204, curved mirror 210, and collection lens 212 may each be shifted 1 mm upward or extended 1 mm in a height or z-dimension to increase light collection efficiency from a bottom (the direction of a face of body 202 where a sample exits flow channel 206) of the cuvette 124.

Curved mirror 210 may be a plano-concave back-surface mirror made of optically transparent materials that may have refractive index similar to that of body 202, such as glass, quartz, or optical quality plastic. Curved mirror 210 may have a flat front surface optically coupled to an abutting flat surface of body 202 to minimize optical losses. Optical coupling of the curved mirror 210 to body 202 may be accomplished, for example, by an index-matching gel, optical adhesive, or direct optical bonding.

Physical dimensions of the curved mirror may restrict collection of light and prevent detection of light from the corners of the channel that could potentially generate additional noise/background. The expanded flow channel 206, as described in association with various example embodiments disclosed herein, can introduce additional noise due to the wider collection angle collecting light which impinges upon the edges of the flow channel. Restricting the dimensions of the curved mirror redirects light to avoid these potential sources of noise and improves separation between noise and particle signals.

Physical dimensions of curved mirror 210 are configured to restrict collection of light and prevent detection of light scattered from the corners of the channel, rather than the sample, that could potentially generate additional noise or background. Together, the physical dimensions of curved mirror 210 and the inner dimensions of flow channel 206 determine a numerical aperture of cuvette 124. In embodiments, the numerical aperture may be configured to provide a wide collection angle and reduce noise generated by scatter from the edges of flow channel 206. Numerical aperture may be less than 1.28, less than 1.27, less than 1.26, or less than 1.25. Numerical aperture may be substantially equal to 1.24.

Collection lens 212 is disposed oppositely of curved mirror 210 across body 202 of cuvette 124. Optical coupling of collection lens 212 to body 202 may be accomplished, for example, by an index-matching gel, optical adhesive, or direct optical bonding. Together, curved mirror 210 and collection lens 212 provide collection optics to focus side scatter light into a detection fiber. In embodiments, curved mirror and collection lens may each have a length substantially equal to 80%, 85%, 90%, 95%, 96%, 97%, or 100% of the length of the body. In embodiments, curved mirror 210 may have a reduced length, as compared with the collection lens 212, rather than being substantially equal in length to the collection lens. For example, collection lens 212 may have a length approximately 96% of the length of the body 202 and curved mirror 210 may have a length approximately 90% of the length of the body 202.

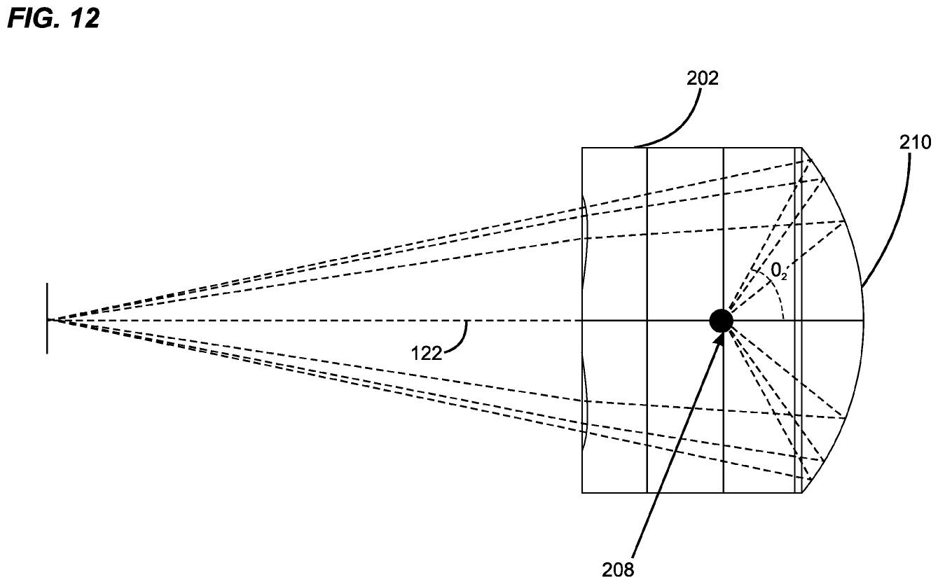

Referring now to FIG. 12, a diagram of an example side scatter travel path in a cuvette embodying aspects of the present disclosure, including a collection angle. For reference, interrogation point 208 and curved mirror 210 are labeled.

As has been discussed throughout, an excitation beam 122 enters body 202 and intersects with a sample at interrogation point 208. Fluorescence and light are scattered or emitted from the interrogation point 208 due to this interaction between the sample and the illumination/excitation beam 122, and light scatter to the side is reflected by curved mirror 210. The angle between the illumination/excitation beam and the scattered light that meets the curved mirror 210 is the collection angle of the scattered or emitted light. In embodiments, a collection angle greater than 54 degrees may be desirable, to provide wider collection of scatter from the interrogation point 208 and increase the sensitivity of the flow cytometer. In embodiments, a collection angle greater than 55 degrees, 60 degrees, 65 degrees, 70 degrees, or 75 degrees may be desirable. In embodiments, the collection angel is configured to be substantially equal to 72 degrees.

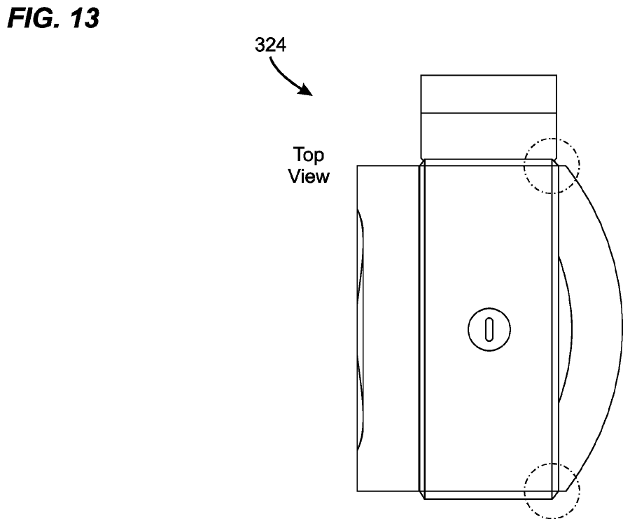

Various example flow cell assemblies are now described with reference to FIGS. 13-24.

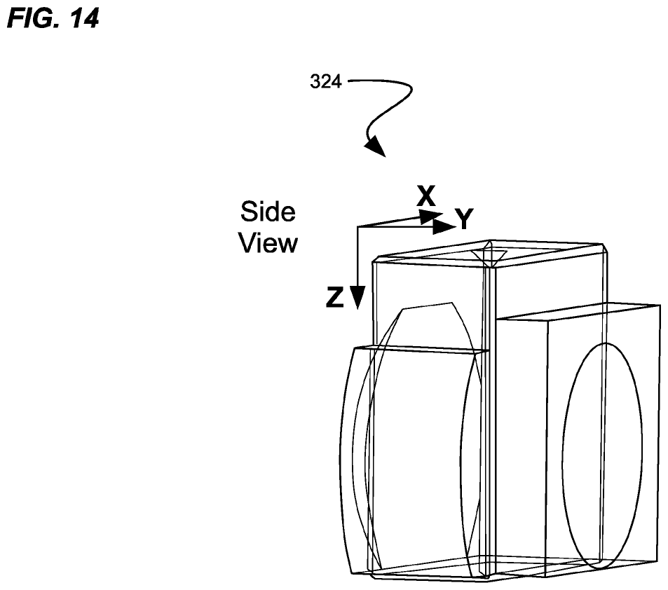

Referring now to FIGS. 13 and 14, an example cuvette assembly 324 is shown according to the measurements of Table 1 below:

TABLE 1
Dimensions of example cuvette assembly 324

Dimensions

| | Length (Y) | Width (X) | Height (Z) |
|---|---|---|---|
| | (mm) | (mm) | (mm) |
| Flow cell body | 10.00 | 4.10 | 10.00 |
| Channel | 0.60 | 0.18 | 10.00 |
| dimensions | | | |
| Curved mirror | 9.60 | 1.90 | 8.00 |
| Collection lens | 9.60 | 1.83 | 8.00 |
| Beam shaper lens | 2.50 | 4.10 | 7.00 |

Cuvette assembly 324 features an extended y-axis dimension in both the body and the flow channel, relative to a x-dimension, to provide a wide collection angle for the scattered/emitted light from the sample. Cuvette assembly 324 also features an extended z-dimension, relative to the x-dimension, to provide stability to the core stream when sample and/or sheath flow rates are low. Each of the curved mirror and the collection lens of cuvette assembly 324 are also extended in the y- and z-dimensions to accommodate the wide collection angle of the scattered/emitted light from the sample. In example cuvette assembly 324, the curved mirror and collection lens are each substantially occupy 96% of the length of the face of the body to which they are affixed. Together, the physical dimensions of the channel and the curved mirror determine a numerical aperture of the assembly. Example cuvette assembly 324 has a numerical aperture equivalent to about 1.08 with a collection angle of about 72 degrees.

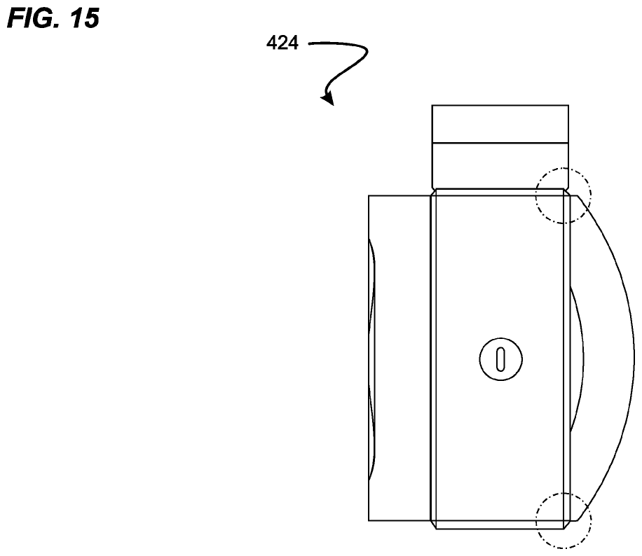

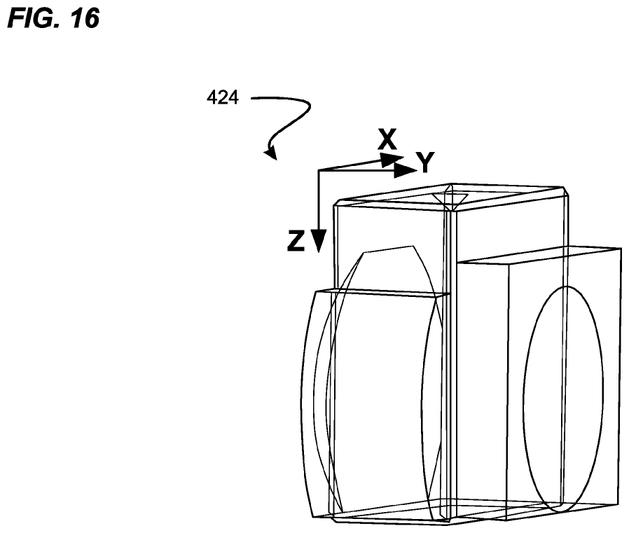

Referring now to FIGS. 15 and 16, another example cuvette assembly 424 is shown according to the measurements of Table 2 below:

TABLE 2
Dimensions of example cuvette assembly 424

Dimensions

| | Length (Y) | Width (X) | Height (Z) |
|---|---|---|---|
| | (mm) | (mm) | (mm) |
| Flow cell body | 10.00 | 4.10 | 10.00 |
| Channel | 0.60 | 0.18 | 10.00 |
| dimensions | | | |
| Curved mirror | 9.00 | 1.90 | 8.00 |
| Collection lens | 9.60 | 1.83 | 8.00 |
| Beam shaper lens | 2.50 | 4.10 | 7.00 |

Cuvette assembly 424 has a shortened y-dimension of the curved mirror, as compared to cuvette assembly 324, which enables the mirror to avoid collecting scatter light from the corners of the channel that potentially could generate extra noise to the system.

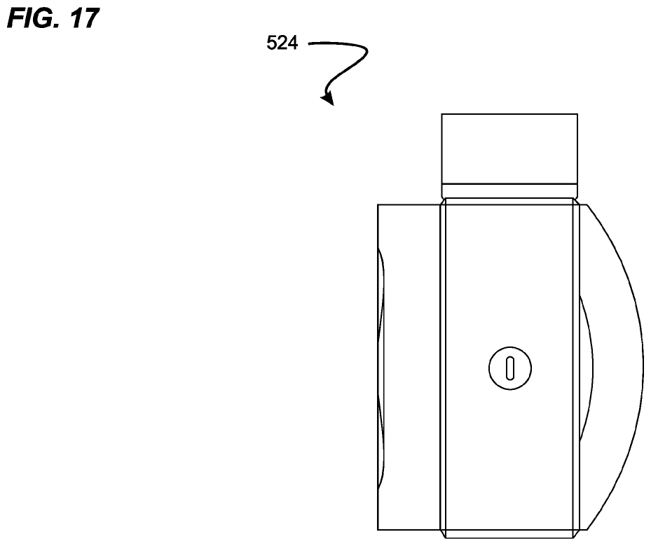

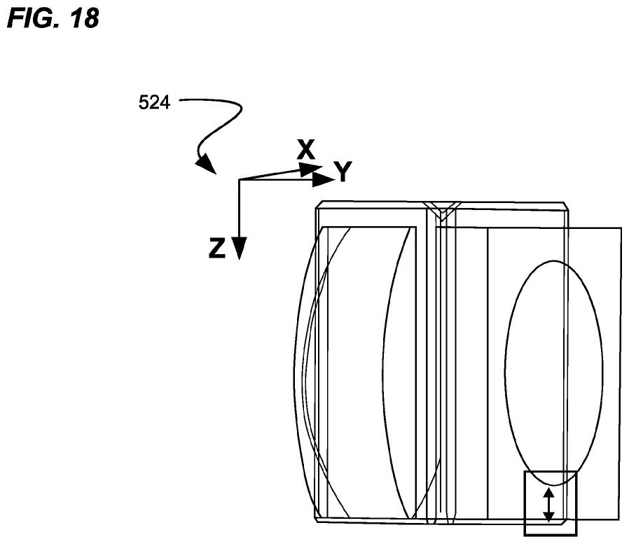

Referring now to FIGS. 17 and 18, another example cuvette assembly 524 is shown according to the measurements of Table 3 below:

TABLE 3
Dimensions of example cuvette assembly 524

Dimensions

| | Length (Y) | Width (X) | Height (Z) |
|---|---|---|---|
| | (mm) | (mm) | (mm) |
| Flow cell body | 10.00 | 4.10 | 10.00 |
| Channel | 0.60 | 0.18 | 10.00 |
| dimensions | | | |
| Curved mirror | 9.00 | 1.90 | 9.00 |
| Collection lens | 9.60 | 1.83 | 9.00 |
| Beam shaper lens | 2.50 | 4.10 | 9.00 |

Cuvette assembly 524 shifts the interrogation point by 1 mm by lengthening the z-dimension of the curved mirror, the collection lens, and the beam shaper lens, as compared with cuvette assemblies 324 and 424. This shift in the interrogation point provides a wider collection angle relative to the bottom of the flow cell assembly. Cuvette assembly 524, in embodiments, lifts each of the curved mirror, the collection lens, and the beam shaper lens 1 mm upward (toward a face of the cuvette including the sample entry point) to increase light collection efficiency from the bottom of the flow cell.

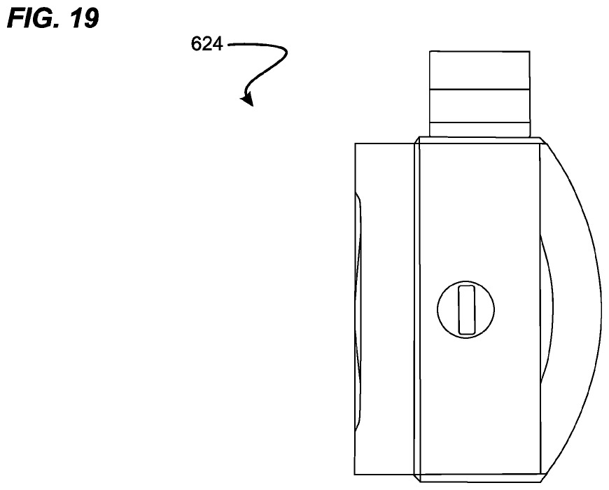

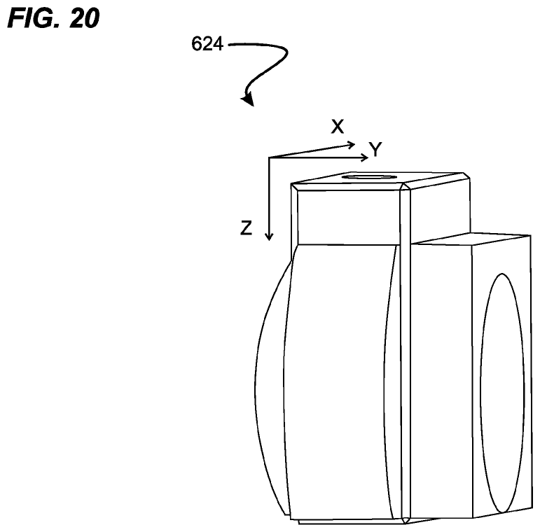

Referring now to FIGS. 19 and 20, another example cuvette assembly 624 is shown according to the measurements of Table 4 below:

TABLE 4
Dimensions of example cuvette assembly 624

Dimensions

| | Length (Y) | Width (X) | Height (Z) |
|---|---|---|---|
| | (mm) | (mm) | (mm) |
| Flow cell body | 10.00 | 3.50 | 10.00 |
| Channel | 1.30 | 0.40 | 10.00 |
| dimensions | | | |
| Curved mirror | 9.60 | 1.90 | 8.00 |
| Collection lens | 9.60 | 1.83 | 8.00 |
| Beam shaper lens | 2.50 | 3.00 | 8.00 |

Cuvette assembly 624 has the y-dimension and the z-dimension of the body and the flow channel further extended, relative to the x-dimension and as compared to cuvette assemblies 324, 424, 524, to further accommodate a larger collection angle of the scattered/emitted light and the fluidics requirements to provide a more stable core stream for low flow rates of the sample and sheath fluid. This may be due to elongating one or both of the y-dimension or the z-dimension, or by reducing the x-dimension, to collect scatter and fluorescent light to a focal point.

Though cuvette assembly 624, including the body, the flow channel, the curved mirror, and the collection lens, is generally larger than cuvette assemblies 324, 424, 524, it is notable that all four assemblies have a similar aspect ratio of approximately 3.25. Cuvette assembly 624 may have an aspect ratio substantially equal to 3.25, while other cuvette assemblies embodying aspects of the present disclosure may have aspect ratios of greater than 3.00, greater than 3.10, greater than 3.20, greater than 3.30, or greater than 3.40. Example flow cell assemblies embodying aspects of the present disclosure have an aspect ratio substantially equal to 3.33.

Cuvette assembly 624 may have different fluidics configurations as compared to cuvette assemblies 324, 424, 524. The expanded channel dimensions of cuvette assembly 624 enables acceleration of sheath flow rate and permits changing the configuration of the instrument from colinear laser design to spatially separated laser design.

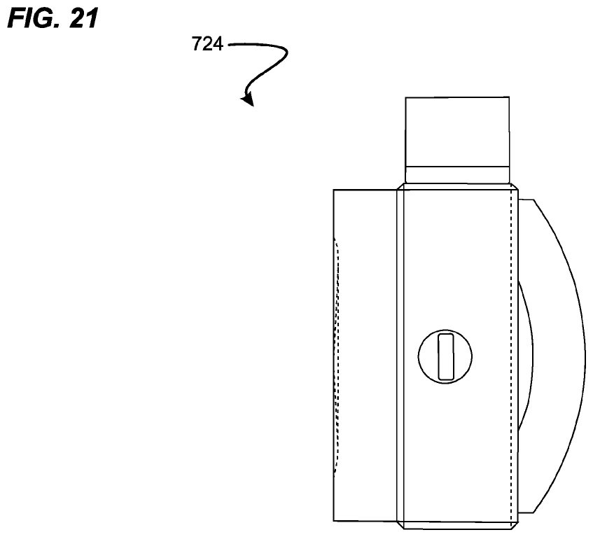

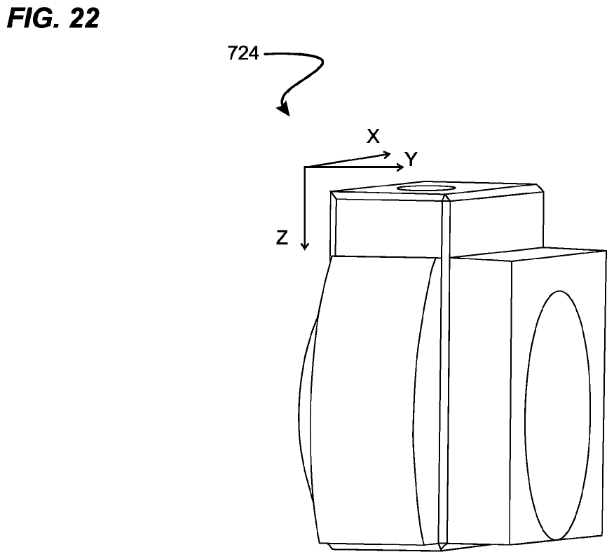

Referring now to FIGS. 21 and 22, another example cuvette assembly 724 is shown according to the measurements of Table 5 below:

TABLE 5
Dimensions of example cuvette assembly 724

Dimensions

| | Length (Y) | Width (X) | Height (Z) |
|---|---|---|---|
| | (mm) | (mm) | (mm) |
| Flow cell body | 10.00 | 3.50 | 10.00 |
| Channel | 1.30 | 0.40 | 10.00 |
| dimensions | | | |
| Curved mirror | 9.00 | 1.90 | 8.00 |
| Collection lens | 9.60 | 1.83 | 8.00 |
| Beam shaper lens | 2.50 | 3.00 | 8.00 |

Cuvette assembly 724 substantially resemble cuvette assembly 624 with a reduced y-dimension of the curved mirror to provide greater control on avoiding collection of light scatter from the corners of the channel, rather than the sample, which may contribute to system noise.

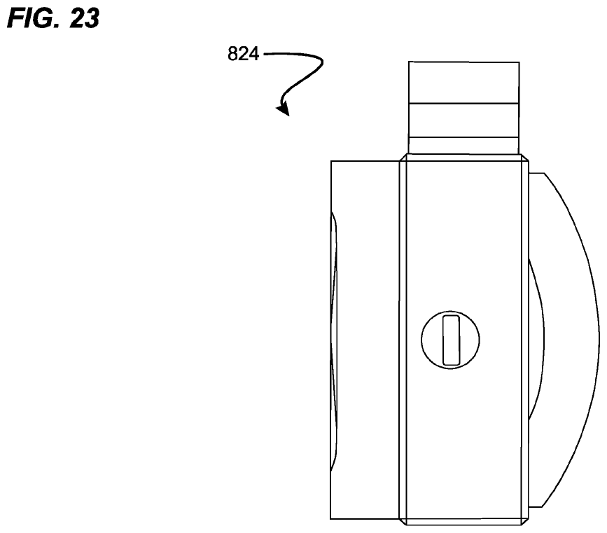

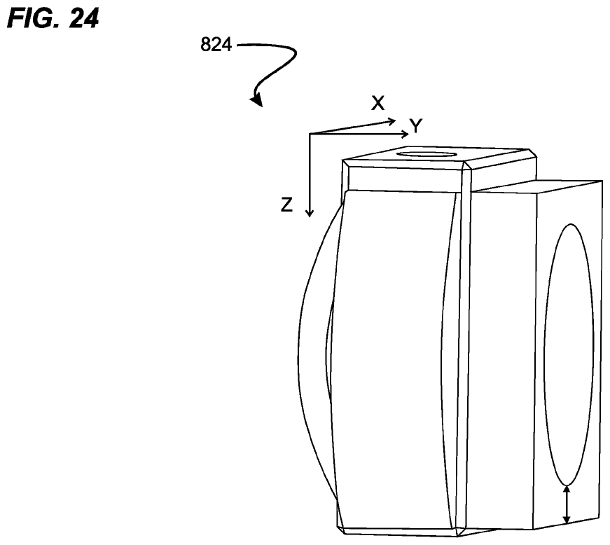

Referring now to FIGS. 23 and 24, another example cuvette assembly 824 is shown according to the measurements of Table 6 below:

TABLE 6
Dimensions of example cuvette assembly 824

Dimensions

| | Length (Y) | Width (X) | Height (Z) |
|---|---|---|---|
| | (mm) | (mm) | (mm) |
| Flow cell body | 10.00 | 3.50 | 10.00 |
| Channel | 1.30 | 0.40 | 10.00 |
| dimensions | | | |
| Curved mirror | 9.00 | 1.90 | 9.00 |
| Collection lens | 9.60 | 1.83 | 9.00 |
| Beam shaper lens | 2.50 | 3.00 | 9.00 |

Cuvette assembly 824 shifts the interrogation point by increasing the z-dimension of the curved mirror, the collection lens, and the beam shaper lens. This shift in the interrogation point increases the collection angle from a bottom face of the flow cell assembly. The example assemblies discussed herein and other flow cells embodying aspects of the present disclosure provide an optimized flow cell design and design of the corresponding collection optics.

Illustrative examples of the systems and methods described herein are provided below. An embodiment of the system or method described herein may include any one or more, and any combination of, the clauses described below.
Clause 1. A cuvette for a flow cytometer, including: a body defining a flow channel having an inner dimension configured to maintain a size and a velocity of a core stream of a sample in a sheath fluid; an interrogation point in the flow channel; and a curved mirror to capture fluorescence emitted and light scattered by the sample at a collection angle and reflect the emitted fluorescence and the scattered light to be collected, the curved mirror configured such that the collection angle is greater than 55 degrees.
Clause 2. The cuvette of clause 1, further comprising a collection lens to collect the fluorescence and scattered light directly from the sample and reflected by the curved mirror.
Clause 3. The cuvette of clause 1, wherein the collection angle is greater than 60 degrees.
Clause 4. The cuvette of clause 1, wherein the collection angle is greater than 70 degrees.
Clause 5. The cuvette of clause 1, wherein the collection angle is substantially equal to 72 degrees.
Clause 6. A cuvette for a flow cytometer, including: a body defining a flow channel having an inner dimension configured to maintain a size and a velocity of a core stream of a sample in a sheath fluid, the body including a body length; an interrogation point in the flow channel; and a curved mirror and a collection lens, together configured to capture fluorescence emitted and light scattered by the sample, wherein each of the curved mirror and the collection lens has a length that is at least 90% of the body length.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A high sensitivity flow cell for a flow cytometer, comprising:
a cuvette having:
a body including a body height, a body length, and a body width; and
a flow channel passing centrally through the body along the body height and having an inner dimension through which a sample flows and intersects with an excitation beam at an interrogation point, wherein the inner dimension has an aspect ratio of at least 2.39.

2. The high sensitivity flow cell of claim 1, further comprising a curved mirror affixed to the body and configured to reflect side scatter and fluorescence from the interrogation point; and
a collection lens disposed opposite from the curved mirror across the width of the body and configured to collect the side scatter and fluorescence directly from the sample and reflected by the curved mirror.

3. The high sensitivity flow cell of claim 1, wherein the aspect ratio is at least 3.30.

4. The high sensitivity flow cell of claim 3, wherein the aspect ratio is 3.33.

5. The high sensitivity flow cell of claim 1, wherein the inner dimension comprises a channel length and a channel width, wherein the channel length is 0.6 mm and the channel width is 0.18 mm.

6. The high sensitivity flow cell of claim 1, wherein the inner dimension comprises a channel length and a channel width, wherein the channel length is 1.3 mm and the channel width is 0.4 mm.

7. The high sensitivity flow cell of claim 1, wherein the excitation beam is provided by a spatially separate laser.

8. The high sensitivity flow cell of claim 1, wherein the excitation beam is provided by a colinear laser.

9. The high sensitivity flow cell of claim 1, wherein the body length is at least 2.4× greater than the body width.

10. The high sensitivity flow cell of claim 9, wherein the curved mirror has a mirror length and the collection lens has a lens length, and each of the mirror length and the lens length at substantially 96% of the body length such that the curved mirror and the collection lens accommodate the wide collection angle of the side scatter produced.

11. The high sensitivity flow cell of claim 9, wherein the curved mirror has a mirror length at substantially 90% of the body length such that the curved mirror avoids collecting noise scattered from the flow channel.

12. The high sensitivity flow cell of claim 1, wherein the inner dimension and curved mirror are together configured to provide a numerical aperture of at least 1.24.

13. The high sensitivity flow cell of claim 12, wherein the inner dimension and curved mirror are together configured to provide a numerical aperture of substantially 1.24.

14. The high sensitivity flow cell of claim 12, wherein the inner dimension and curved mirror are together configured to provide a numerical aperture of no more than 1.27.
